(19) United States
(12) Patent Application Publication
(10) Pub. No.: US 2002/0044719 A1
(43) Pub. Date: Apr. 18, 2002

(54) Controllable optical switching module

(76) Inventors: Hubert Jaeger, Pullach (DE); Oliver Jahreis, Muenchen (DE); Arnold Monitzer, Muenchen (DE)

Correspondence Address: BELL, BOYD & LLOYD, LLC, P. O. BOX 1135, CHICAGO, IL, 60690-1135, US

(21) Appl. No.: 09/925,665

(22) Filed: Aug. 9, 2001

(30) Foreign Application Priority Data
Sep. 8, 2000 (DE) 10038951.1

(51) Int. Cl. G02B 6/35; H04J 14/02

(52) U.S. Cl. 385/17; 385/16; 359/128

(57) ABSTRACT

A controllable optical switching module (OSM) has at least N optical inputs (i1 to iN) and at least N optical outputs (e1 to eN) for selectively switching through optical signals (os1 to osN), with a respective optical signal (os1 to osN) being able to be switched through from an optical input (i1 to iN) via a respective switching point (SP) in a switching matrix (SM) to an optical output (e1 to eN) using a control unit (CU). The order of the arrangement of the optical inputs (i1 to iN) is determined by virtue of the respective attenuation (A1 to AN) produced when the optical signals (os1 to osN) are switched through from an optical input (i1 to iN) via a switching point (SP) to an optical output (e1 to eN) increasing or decreasing from the first to the Nth optical input (i1 to iN).

### BACKGROUND OF THE INVENTION

The present invention relates to controllable optical switching modules having at least N optical inputs and at least N optical outputs for selectively switching through optical signals. A respective optical signal can be switched through from an optical input via a respective switching point in a switching matrix to an optical output using a control unit.

Optical transmission networks on the basis of fiber-connected transmission links having high bit rates and optical crossconnects, also using optical frequency multiplexing, represent the future transport network for transmitting large volumes of data for future telecommunications.

The growth to be expected in the area of data transmission via optical transmission networks, particularly as a result of the increase in Internet access providers and Internet users, makes it necessary to design such optical transmission networks to be as reliable as possible. The reliability of an optical crossconnect for switching through connections from different users having a wide variety of connection requirements must be able to be provided extremely securely, flexibly and within a very short time using an appropriate level of technical complexity.

In this context, the optical crossconnects in the form of fiber-optic distributors provide optical connections such that the optical connections are switched through manually in the respective optical crossconnects, for example using an optical plug connection. For this purpose, two optical conductors having one plug connector each are usually connected to one another by means of such an optical plug connection, the optical plug connection having an optical connecting conductor and two plugs respectively fitted to the ends of the optical connecting conductor. The plugs of the optical connecting conductor are plugged into the optical connections of the optical conductors to be connected, and ultimately this creates an optical connection between a first optical conductor, or a supply line fiber, and a second optical conductor, or a discharge fiber.

To create dynamic optical connections, for example optical connections which are reconfigured several times within one day, controllable optical crossconnects or switching modules are known. In this regard, see the home page for the company OMM http://www.omminc.com/products/2dmems.htm, whose controllable optical switching modules have coupling or switching matrices provided using optical switches or controllable optical mirrors. These can be used for electronically switching optical connections via a network management system, which eliminates the often time consuming manual “plugging” for an optical connection. However, a drawback is that extension, i.e., increasing the optical interfaces of the optical automatically controllable crossconnect or switching module, becomes possible only by virtue of a disproportionately higher level of equipment complexity. If it is desirable to double, for example, the number of optical interfaces of a controllable optical crossconnect, then, in order to ensure that the controllable switching module has a minimum freedom from blocking, it is necessary to cascade optical switching modules in the switching matrix. Such cascading to double the optical interfaces can result in the optical switching modules being more than quadrupled under some circumstances depending on the freedom from blocking required for the controllable switching module.

In addition, cascading optical switching modules increases the transmission loss of the optical crossconnect, which means that additional regeneration of the optical signal transmitted via the optical crossconnect or the cascade of controllable switching modules may be necessary. Another drawback is, in particular, that the individual switching paths from an optical input via a switching point to an optical output of such a controllable optical switching module can have very different attenuations or transmission losses which may be in the range from 4 to 10 dB in the case of relatively large controllable optical switching modules or switching matrices (16*16 or 32*32 inputs/outputs). As a result of such high attenuation values, the optical signals transmitted via a three-stage switching network (Klos structure), for example, constructed using such controllable optical switching modules are attenuated to such an extent that the optical signal produced at the output of the switching network cannot be reconstructed again or cannot be processed further again. These attenuation values (which are high particularly in the case of a large switching matrix and result from manufacturing tolerances) for individual switching paths or switching points within a controllable optical switching module considerably reduce the reliability of the controllable switching module per se and of the whole switching network or of the optical crossconnect.

### SUMMARY OF THE INVENTION

One aspect of the present invention is to improve the reliability of a controllable optical switching module in terms of the attenuation produced when switching through an optical signal from an optical input via a switching point to an optical output.

In one embodiment, a controllable optical switching module (OSM) is provided having at least N optical inputs (i1 to iN) and at least N optical outputs (e1 to eN) for selectively switching through optical signals (os1 to osN), with a respective optical signal (os1 to osN) being able to be switched through from an optical input (i1 to iN) via a respective switching point (SP) in a switching matrix (SM) to an optical output (e1 to eN) using a control unit (CU). The order of the arrangement of the optical inputs (i1 to iN) is determined by virtue of the respective attenuation (A1 to A2) produced when the optical signals (os1 to osN) are switched through from an optical input (i1 to iN) via a switching point (SP) to an optical output (e1 to eN) increasing or decreasing from the first to the Nth optical input (i1 to iN).

Another aspect of the inventive controllable optical switching module is that the order of the arrangement of the optical inputs is determined by virtue of the respective attenuation produced when the optical signals are switched through from an optical input via a switching point to an optical output increasing or decreasing from the first to the Nth optical input. Advantageously, the attenuation values of the connection paths which can be switched through the switching matrix are ascertained and the ascertained attenuation values are used to match the order of the optical inputs of the controllable optical switching module to the ascertained attenuation values. Thus, by way of example, attenuation values for the first N optical inputs can increase or decrease from the first to the Nth optical input, where the order should be understood as meaning any desired order of the arrangement of the optical inputs or optical connection points of the controllable optical switching module. This means advantageously, that the optical inputs connected to a connection path which has a low attenuation value and runs from an input via a switching point to an output are preferably arranged in an order such that they are preferably connected for transmitting optical signals, with the other optical inputs, which have higher attenuation values, being used for switching only to a limited extent, or low-priority optical signals being routed to these optical inputs. Using the inventive controllable optical switching module, the reliability of already existing optical crossconnects or switching matrix arrangements can be increased considerably in the case of an increase in the switching matrices of N=16 or N=32, for example, and the already existing hardware and software of the optical crossconnects or switching matrix arrangements can also essentially continue to be used.

According to another aspect of the invention, the order of the arrangement of the optical outputs is determined by the order of the optical inputs connected to the optical outputs via a respective switching point. Advantageously, although the novel arrangement of the optical outputs with respect to the optical inputs provides a controllable optical switching module whose number of connections is reduced, for example 8*16 or 8*14, the reliability of the controllable optical switching module having a reduced number of connections has been significantly increased. With the available switching connections of the reduced controllable optical switching module, it is virtually impossible for any loss or excessive attenuation of the optical signal which is to be switched through to occur.

In accordance with another aspect of the controllable optical switching module, at least one matching unit is provided for matching the optical switching inputs and/or the optical switching outputs of the switching matrix of the optical controllable switching module to the order, stipulated by the attenuation, of the arrangement of the optical inputs and of the optical outputs. Advantageously, the at least one matching unit connects the individual optical switching inputs and outputs of the switching matrix to the arrangement of the optical inputs and outputs of the controllable optical switching module on the basis of the attenuation values of said switching inputs and outputs. This means that the optical switching inputs and outputs of the optical switching matrix which are stipulated by manufacture are connected to different optical inputs and outputs of the controllable optical switching module which are no longer arranged in the order of the original optical switching inputs and outputs.

According to another aspect of the invention, with increasing attenuation (A1<A2< . . . <AN), a connection path having the lowest attenuation (Al) contains the first optical input (i1) and/or the first optical output (e1), and with decreasing attenuation (A1>A2> . . . >AN), a connection path having the highest attenuation (A1) contains the first optical input (i1) and/or the first optical output (e1).

According to another aspect of the invention, with increasing attenuation, (A1<A2< . . . <AN), a connection path having the highest attenuation (AN) contains the Nth optical input (iN) and/or the Nth optical output (eN), and with decreasing attenuation (A1>A2> . . . AN), a connection path having the lowest attenuation (AN) contains the Nth optical input (iN) and the Nth optical output (eN).

According to another aspect of the invention, the order, stipulated using the at least one matching unit (AU1, AU2), of the arrangement of the optical inputs (i1 to iN) and of the optical outputs (e1 to eN) is taken into account in the control unit (CU) when optical signals (os1 to osN) are switched through.

According to another aspect of the invention, the first, second and third switching stages have controllable optical switching modules (OSM) having 2*N inputs (i1 to i2N) and 2*N outputs (e1 to e2N), with N controllable optical switching modules (OSM) being connected in parallel in the first and third switching stages, and 2*N controllable optical switching modules (OSM) being connected in parallel in the second switching stage. Optical supply line fibers are respectively connected to the first N inputs (i1 to iN), having the lowest attenuation values, of the N controllable optical switching modules (OSM) arranged in the first switching stage. A respective output (e1 to e2N) of a controllable optical switching module (OSM) arranged in the first switching stage is connected to precisely one input (i1 to i2N) of a 2*N controllable optical switching module (OSM) arranged in the second switching stage. A respective input (i1 to i2N) of a controllable optical switching module (OSM) arranged in the third switching stage is connected to precisely one output (e1 to e2N) of a 2*N controllable optical switching module (OSM) arranged in the second switching stage. Optical discharge fibers are respectively connected to the first N outputs (e1 to eN), having the lowest attenuation values, of the N controllable optical switching modules (OSM) arranged in the third switching stage.

Additional features and advantages of the present invention are described in, and will be apparent from, the following Detailed Description of the Invention and the figures.

### BRIEF DESCRIPTION OF THE FIGURES

FIG. 1 shows the basic design of the inventive controllable optical switching module.

### DETAILED DESCRIPTION OF THE INVENTION

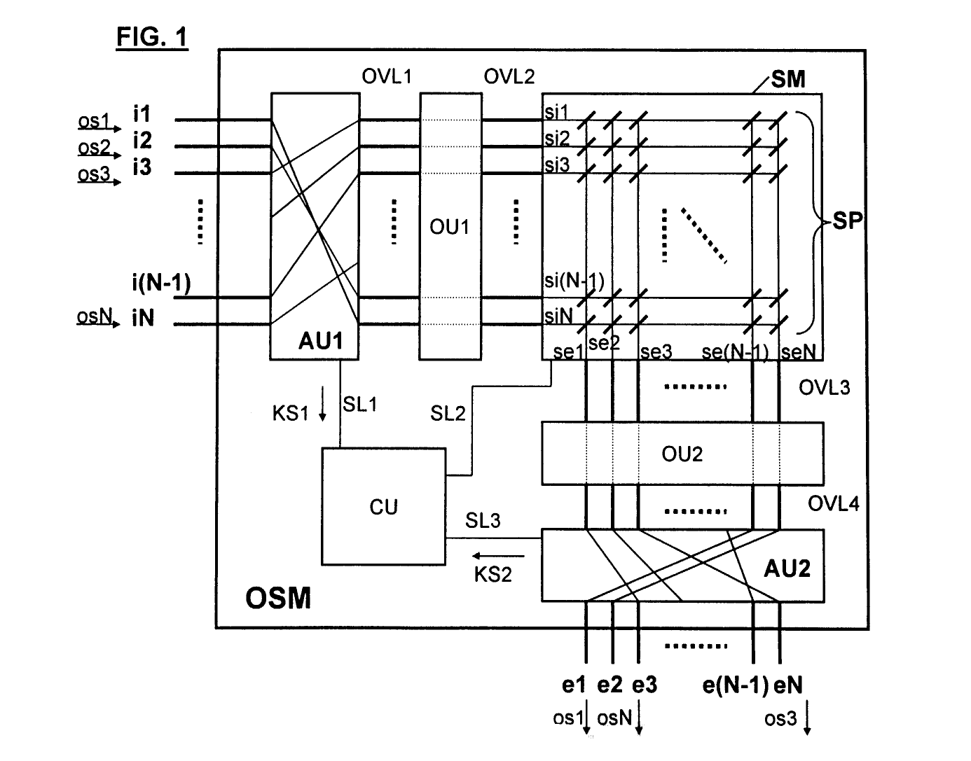

FIG. 1 shows, by way of example, the basic design of the inventive controllable optical switching module OSM, which has one to Nth optical inputs i1 to iN, one to Nth optical outputs e1 to eN, a first and a second optical matching unit AU1, AU2, a first and a second optical unit OU1, OU2, an optical switching matrix unit SM having a plurality of optical switching points SP, and a control unit CU.

The one to Nth optical inputs i1 to iN are connected to the first matching unit AU1, which is connected to the first optical unit OU1 by means of first optical connecting lines OVL1. In addition, the first matching unit AU1 is connected to the control unit CU by means of a first control line SL1, and the first optical unit OU1 is additionally connected by means of second optical connecting lines OVL2 to the to Nth optical switching inputs si1 to siN of the optical switching matrix unit SM. The one to Nth optical switching inputs si1 to siN can be respectively connected via an optical switching point SP, for example a controllable optical mirror, to each one to Nth switching output se1 to seN of the optical switching matrix unit SM. FIG. 1 shows only some of the possible optical switching points SP and of the switchable connections for reasons of clarity. The optical switching matrix unit SM is connected to the control unit CU by means of a second control line SL2. The one to Nth optical switching outputs se1 to seN are connected by means of third optical connecting lines OVL3 to the second optical unit OU2, which is connected to the second matching unit AU2 by means of fourth optical connecting lines OVL4. In addition, the second matching unit AU2 is connected by means of a third control line SL3 to the control unit CU and is connected to the one to Nth optical outputs e1 to eN of the controllable optical switching module OSM.

According to the invention, the first matching unit AU is used to determine the order of the arrangement of the first to Nth optical inputs i1 to iN by virtue of the respective attenuation A1 to AN produced when switching through optical signals os1 to osN from an optical input i1 to iN via an optical switching point SP to an optical output e1 to eN increasing or decreasing from the first to the Nth optical input i1 to iN. In FIG. 1, by way of example, the first optical input i1 has the lowest attenuation or first attenuation A1, and the second to Nth attenuation A2 to AN of the second to Nth optical inputs i2 to iN increases with the arrangement order of the first to Nth optical inputs i1 to iN, i.e. the first to Nth attenuation A1 to AN increases with the connection number of the optical inputs i1 to iN [A1<A2<A3< . . . <A(N−1)<AN]. Thus, by way of example, the first three optical inputs i1 to i3 have the lowest three attenuation values a1 to a3 which can be produced using the optical switching matrix unit SM and which may be situated in the range from 1 to 3 dB, for example.

For this purpose, the first optical connecting lines OVL1, for example running parallel to the first to Nth optical switching inputs se1 to siN, are matched or connected on the basis of their attenuation values A1 to AN to the inventive arrangement of the first to Nth optical inputs i1 to iN using the first matching unit AU1.

Similarly to this, the fourth optical connecting lines OVL4, for example running parallel to the first to Nth optical switching outputs se1 to seN, are matched or connected on the basis of their attenuation values A1 to AN to the inventive arrangement of the first to Nth optical outputs e1 to eN using the second matching unit AU2.

This allows the switching paths which have the lowest attenuation and are therefore the most reliable, for example from the first optical input via a switching point SP to the Nth optical output EN, to be arranged specifically as first to third optical inputs i1 to i3 and as first to third optical outputs. The controllable optical switching module OSM, which is produced as a result, has a reduced number of connections and uses only the most reliable switching points SP of the optical switching matrix unit SM and can be used for selectively switching through optical signals os1 to osN reliably.

The order, stipulated using the first and second matching units AU1 to AU2, of the arrangement of the first to Nth optical inputs i1 to iN and of the first to Nth optical outputs e1 to eN with respect to the first to Nth optical switching inputs si1 to siN and of the first to Nth optical switching outputs se1 to seN is transmitted to the control unit CU using a first and a second configuration signal KS1, KS2, i.e. the control unit CU is notified of which of the one to Nth optical inputs and outputs i1 to iN, e1 to eN is connected to which one to Nth optical switching input and output si1 to siN, se1 to seN.

Thus, the first to Nth optical signals os1 to osN routed to the one to Nth optical inputs i1 to iN are transmitted to the first to Nth switching input si1 to siN of the optical switching matrix unit SM via the first matching unit AU1 and via the first optical unit OU1. The first optical unit OU1 is provided for inputting the first to Nth optical signal os1 to osN into the optical switching matrix unit SM.

The first to Nth optical signals os1 to osN are switched through to the respective one to Nth optical switching input using the optical switching matrix unit SM and are transmitted via the third optical connecting lines to the second optical unit OU2, which is provided for outputting the switched-through first to Nth optical signal os1 to osN from the optical switching matrix unit SM.

The second optical unit OU2 transmits the switched-through first to Nth optical signal os1 to osN via the fourth optical connecting lines to the second matching unit AU2, which is used to match or switch through the first to Nth optical signal os1 to osN to the respective associated first to Nth optical output e1 to eN. The second matching unit AU2 is optional and can also be omitted in accordance with the invention.

In addition, if appropriate, the inventive controllable optical switching modules OSM can be cascaded—not shown in FIG. 1—in order to construct a blocking-free optical crossconnect, for example.

Such an optical crossconnect has at least a first, a second and a third switching stage which are each constructed from a plurality of parallel-connected inventive controllable switching modules OSM. In this case, the first, second and third switching stages are constructed from the inventive controllable optical switching modules OSM having 2*N optical inputs i1 to i2N and 2*N optical outputs e1 to e2N, with N controllable optical switching modules OSM being connected in parallel in the first and third switching stages, and 2*N controllable optical switching modules OSM being connected in parallel in the second switching stage. In addition, optical supply line fibers are respectively connected to the first N optical inputs i1 to iN, having the lowest attenuation values A1 to AN, of the N controllable optical switching modules OSM arranged in the first switching stage. In addition, a respective optical output of a controllable optical switching module OSM arranged in the first switching stage is connected to precisely one optical input of a 2*N controllable optical switching module OSM arranged in the second switching stage. Similarly, a respective optical input of a controllable optical switching module OSM arranged in the third switching stage is connected to precisely one optical output of a 2*N controllable optical switching module OSM arranged in the second switching stage. In addition, optical discharge fibers are respectively connected to the first N outputs, having the lowest attenuation values A1 to AN, of the N controllable optical switching modules OSM arranged in the third switching stage.

The illustrated structure of the optical crossconnect represents only one of a multiplicity of switching matrix arrangements which may be provided using the inventive controllable optical switching module OSM.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A controllable optical switching module for selectively switching through optical signals (os1 to osN), comprising:
at least N optical inputs (i1 to iN);
at least N optical outputs (e1 to eN);
a switching matrix having a plurality of switching points; and
a control unit switching through a respective optical signal (os1 to osN) from one of the optical inputs (i1 to iN) via a respective one of the switching points in the switching matrix to one of the optical outputs (e1 to eN);
an order of arrangement of the optical inputs (i1 to iN) being determined by a respective attenuation (A1 to AN) produced when the optical signals (os1 to osN) are switched through from the optical inputs (i1 to iN) via the switching points to the optical outputs (e1 to eN) increasing or decreasing from the first to the Nth optical input (i1 to iN).

2. The controllable optical switching module as claimed in claim 1, wherein an order of arrangement of the optical outputs is determined by the order of the optical inputs connected to the optical outputs via a respective switching point.

3. The controllable optical switching module as claimed in claim 1, further comprising at least one matching unit matching optical switching inputs (si1 to si2) of the switching matrix and/or optical switching outputs (se1 to seN) of the switching matrix to the orders of the arrangement of the optical inputs (i1 to iN) and of the optical outputs (e1 to eN) according to the attenuations (A1 to AN).

4. The controllable optical switching module as claimed in claim 2, further comprising at least one matching unit matching optical switching inputs (si1 to si2) of the switching matrix and/or optical switching outputs (se1 to seN) of the switching matrix to the orders of the arrangement of the optical inputs (i1 to iN) and of the optical outputs (e1 to eN) according to the attenuations (A1 to AN).

5. The controllable optical switching module as claimed in any one of claims 1 to 4, wherein with increasing attenuation (A1<A2< . . . <AN), a connection path having the lowest attenuation (A1) contains the first optical input (i1) and/or the first optical output (e1), and wherein with decreasing attenuation (A1>A2> . . . >AN), a connection path having the highest attenuation (A1) contains the first optical input (i1) and/or the first optical output (e1).

6. The controllable optical switching module as claimed in any one of claims 1 to 4, wherein with increasing attenuation, (A1<A2< . . . <AN), a connection path having the highest attenuation (AN) contains the Nth optical input (iN) and/or the Nth optical output (eN), and wherein with decreasing attenuation (A1>A2> . . . >AN), a connection path having the lowest attenuation (AN) contains the Nth optical input (iN) and the Nth optical output (eN).

7. The controllable optical switching module as claimed in claim 3, wherein the orders of the arrangement of the optical inputs (i1 to iN) and of the optical outputs (e1 to eN) are processed in the control unit when the optical signals (os1 to osN) are switched through.

8. The controllable optical switching module as claimed in claim 4, in that the orders of the arrangement of the optical inputs (i1 to iN) and of the optical outputs (e1 to eN) are processed in the control unit when the optical signals (os1 to osN) are switched through.

9. The controllable optical switching module as claimed in claim 5, in that the orders of the arrangement of the optical inputs (i1 to iN) and of the optical outputs (e1 to eN) are processed in the control unit when the optical signals (os1 to osN) are switched through.

10. The controllable optical switching module as claimed in claim 6, in that the orders of the arrangement of the optical inputs (i1 to iN) and of the optical outputs (e1 to eN) are processed in the control unit when the optical signals (os1 to osN) are switched through.

11. An optical crossconnect comprising:
a first, a second and a third switching stage, each switching stage constructed from a plurality of parallel-connected controllable optical switching modules;
each controllable optical switching module comprising: at least N optical inputs (i1 to iN); at least N optical outputs (e1 to eN); a switching matrix having a plurality of switching points; and a control unit switching through a respective optical signal (os1 to osN) from one of the optical inputs (i1 to iN) via a respective one of the switching points in the switching matrix to one of the optical outputs (e1 to eN); an order of arrangement of the optical inputs (i1 to iN) being determined by a respective attenuation (A1 to AN) produced when the optical signals (os1 to osN) are switched through from the optical inputs (i1 to iN) via the switching points to the optical outputs (e1 to eN) increasing or decreasing from the first to the Nth optical input (i1 to iN);
each of the controllable optical switching modules of the first, second and third switching stages having 2*N inputs (i1 to i2N) and 2*N outputs (e1 to e2N), with N controllable optical switching modules being connected in parallel in the first and third switching stages, and 2*N controllable optical switching modules (OSM) being connected in parallel in the second switching stage;
optical supply line fibers are respectively connected to the first N inputs (i1 to iN), having the lowest attenuation values, of the N controllable optical switching modules arranged in the first switching stage;
a respective output (e1 to e2N) of a controllable optical switching module arranged in the first switching stage is connected to precisely one input (i1 to i2N) of a 2*N controllable optical switching module arranged in the second switching stage;
a respective input (i1 to i2N) of a controllable optical switching module arranged in the third switching stage is connected to precisely one output (e1 to e2N) of a 2*N controllable optical switching module arranged in the second switching stage; and
optical discharge fibers are respectively connected to the first N outputs (e1 to eN), having the lowest attenuation values, of the N controllable optical switching modules arranged in the third switching stage.
